(19) United States
(12) Patent Application Publication
(10) Pub. No.: US 2013/0262610 A1
(43) Pub. Date: Oct. 3, 2013

(54) COMMUNICATION SYSTEM AND METHOD FOR CONFIGURING PROGRAMMABLE HARDWARE

(71) Applicants: Andreas-Juergen ROHATSCHEK, Wernau/Neckar (DE); Thorsten Huck, Freiberg (DE); Dieter Thoss, Schwieberdingen (DE); Daniel Drescher, Oberriexingen (DE); Michael Kuhnert, Hemmingen (DE); Stoyan Todorov, Mannheim (DE)

(72) Inventors: Andreas-Juergen ROHATSCHEK, Wernau/Neckar (DE); Thorsten Huck, Freiberg (DE); Dieter Thoss, Schwieberdingen (DE); Daniel Drescher, Oberriexingen (DE); Michael Kuhnert, Hemmingen (DE); Stoyan Todorov, Mannheim (DE)

(73) Assignee: Robert Bosch GmbH, Stuttgart (DE)

(21) Appl. No.: 13/853,358

(22) Filed: Mar. 29, 2013

(30) Foreign Application Priority Data
Mar. 29, 2012 (DE) 10 2012 205 160.0

(51) Int. Cl. H04L 12/24

(52) U.S. Cl. CPC H04L 41/08
USPC 709/208

(57) ABSTRACT

A communication system which has a ring-shaped configuration and has at least two users. The users are connected to one another in series, one user being configured as the master and the remaining users being configured as slaves. The master is configured to transmit a data packet to one or multiple slaves. Each slave has a shift register. At least one user in the communication system includes a programmable hardware module, and at least one user in the communication system includes a memory arrangement. The programmable hardware module is configured so that it may be configured by reading out data of the memory arrangement.

### RELATED APPLICATION INFORMATION

The present application claims priority to and the benefit of German patent application no. 10 2012 205 160.0, which was filed in Germany on Mar. 29, 2012, the disclosure of which is incorporated herein by reference.

### FIELD OF THE INVENTION

The present invention relates to a communication system for configuring or for programming programmable hardware, and a corresponding method.

### BACKGROUND INFORMATION

Serial interfaces are used in many networks instead of parallel interfaces. Reasons for this include the reduction in the costs for the assembly and connection technology, for example, the number of pins, simplification in the system configuration, and a scalability of the bandwidth of transmission data by parallel use of multiple serial interfaces.

This trend, in particular in the field of consumer electronics, has been accompanied by numerous serial interface standards. These serial interface standards are used primarily for communication with peripheral devices, for example a hard drive or display. However, apart from the small number of pins, these interfaces use complex protocols which require a high level of implementation effort. For the data transmission between logic modules (ICs), for example on the motherboard of a PC or within a handheld device, present-day interfaces bundle multiple serial data streams, for example PCI Express or QuickPath, and thus allow scalability of the bandwidth for the system designer.

In the field of automotive engineering, serial peripheral interfaces (SPI) are used in control units for the data transmission between logic modules, which may be configured as integrated circuits (ICs). This standard describes a bidirectional, synchronous, and serial data transmission between a module configured as a master and various modules configured as slaves. An interface includes at least three lines between the master and a slave, which generally are two data lines and one clock line. When there are multiple slaves, each of these modules requires an additional select line from the master. The SPI interface allows the implementation of a daisy chain or bus topology.

In some cases, the SPI interface is not suited for transmitting time-critical control signals in order to meet real-time requirements of present-day safety-critical applications such as ESP. Frequently, only diagnostic and status information is exchanged via an SPI interface. Time-critical control signals are generally transmitted with a high level of complexity to the control modules of the actuators and/or from the evaluation circuits of the sensors, using timer units and/or proprietary interfaces.

In the application of the SPI interface in the form of a bus topology, increasingly poorer signal integrities and high interfering influences result at higher data rates, due to poor EMC properties. In addition, only the transmission signal is synchronously transmitted with the clock signal, while the phase-synchronous transmission of the reception signal may become increasingly difficult due to the internal delay times in the slave at high data rates, and may result in errors in the data transmission.

In the application of the SPI interface in a daisy chain topology, i.e., ring topology, very high latency times result, for which reason it is not possible to efficiently use this form nowadays in motor vehicle control units.

A communication system is known from DE 10 2010 041427 which has clear advantages over the known communication systems. This communication system is ring-shaped (which may be configured in a daisy chain topology) and has at least two users which are connected to one another in series (which may be via point-to-point connections). One master and one or multiple slaves are present among the users. Each of the slaves has a shift register, which may be a 1-bit shift register. It is thus possible to transmit from user to user via the communication system, i.e., over the ring, with a minimum delay of one bit.

For decades, programmable logic modules (for example, field programmable gate arrays (FPGAs)) have been used for prototype development all the way to mid-size series products. The programmable logic system is functionally designed by configuration; i.e., changing the contents of memory elements controls the function of the hardware. The data for the configuration are read out from memory modules (flash memory, for example) and provided to the FPGA. This process is controlled by the FPGA itself (master mode), or is initiated and carried out (slave mode) by an external controller (for example a microcontroller or some other programmable module).

According to the related art, the configuration data (bitstream) are read out from the memory via a serial interface (serial peripheral interface (SPI)) or with the aid of parallel data transmission. In the case of an external controller, the data are subsequently written into the FPGA via an FPGA manufacturer-specific interface. At least one clock line, one data line, and one acknowledge or ready line are necessary. If additional components are now introduced into this transmission path (for example, a second memory or multiple FPGAs), the lines must be multiplied.

A method is discussed in U.S. Pat. No. 7,265,578 B1, for example, for in-system programming via SPI and JTAG. An efficient configuration of programmable logic modules in a daisy chain configuration is discussed in U.S. Pat. No. 7,554,357 B2.

### SUMMARY OF THE INVENTION

The present invention is directed to a communication system according to independent Claim 1. Such a communication system may be ring-shaped (which may be configured in daisy chain topology), and has at least two users which are connected to one another in series (which may be via point-to-point connections). One user may be configured as the master, and the remaining users are configured as slaves.

Microcontrollers, logic modules, and FPGAs in particular are conceivable as the master, and slaves may be configured as functional output stages. The master is also configured to transmit a data packet to one or multiple slaves, and each slave has a shift register via which the data packet is shifted. Such a configuration allows a type of transmission that requires only two pins/signals per user, and also allows additional modules to be introduced into the transmission path. According to the present invention, at least one user in the communication system is a programmable hardware module (an FPGA, for example), and at least one user in the communication system is a memory module. The programmable hardware module is configured in such a way that it is configurable by reading out data of the memory module.

Moreover, the present invention is directed to a method according to the independent method claim. For configuring a programmable hardware module, multiple users may be situated in a ring-shaped communication system and connected to one another in series. One user may be configured as the master and the remaining users are configured as slaves. The master transmits data packets to one or multiple slaves, the data packets running in the slaves via a shift register. The programmable hardware module of one user of the communication system is then configured by reading out data of a memory arrangement of one user of the communication system.

Compared to known systems for configuring programmable hardware modules, many advantages result from such a communication system or from configuration processes carried out in such a communication system. For example, the system has a very small number of lines (as few as two are possible) for configuring such modules, which, in particular for fairly complex systems, may result in a significant reduction in complexity and cost. Furthermore, any additional module in the configuration chain results in only one additional line. The present invention also allows the configuration of a variable configuration chain for FPGAs. Compared to a configuration via SPI, a higher data rate for more than two users is achievable, and in addition longer line paths are possible at the same data rate and with the same EMC properties. The configuration data lines may also be further used here during operation for data transmission for other purposes. In addition, a system having a floating configuration controller (configuration master) which has no fixed position in the data ring is possible with the proposed system.

Further advantages result from the further descriptions herein.

In the proposed communication system, controlling the configuration or programming may be set up in a very flexible manner, and may, for example, be transferred to a specific configuration master, as well as to the user having the hardware module to be configured or programmed.

Due to a very small number of lines compared to known systems, particular efficiency advantages result for the ring-shaped communication system when it is used for a configuration in which either multiple memory arrangements, in particular distributed over multiple users, or multiple programmable hardware modules, in particular distributed over multiple users, are provided. Similarly, the gains in efficiency are particularly great in systems having multiple memory arrangements as well as multiple hardware modules to be configured or programmed.

The master which controls the configuration or programming may either reside permanently in the system (and according to one configuration, take over other functions, for example), or be used only in one configuration phase in the system, and after one configuration phase, taken from the ring, which is then reclosed. This allows flexible use of the configuration master, so that, for example, a configuration master may be repeatedly reused for configuring various hardware modules in various ring systems.

### BRIEF DESCRIPTION OF THE DRAWINGS

FIG. 1 shows a ring-shaped serial communication system.

FIG. 2 shows a communication system which is configured for configuring a programmable hardware module, including a master having a programmable hardware module and a slave having a memory arrangement.

FIG. 3 shows a communication system which is configured for configuring a programmable hardware module, having a configuration master.

FIG. 4 shows a communication system which is configured for configuring a programmable hardware module, including multiple users which have programmable hardware modules.

FIG. 5 shows a communication system which is configured for configuring a programmable hardware module, including two users which have a memory arrangement.

FIG. 6 shows a communication system which is configured for configuring a programmable hardware module, in a configuration phase.

FIG. 7 shows a communication system which is configured for configuring a programmable hardware module, after a configuration phase.

### DETAILED DESCRIPTION

The basic serial, ring-shaped communication system is described initially. At least one slave, in particular a discrete logic module (ASIC), and one master, in particular a logic module such as a microcontroller for monitoring, controlling, and/or regulating the at least one slave, are provided as users of the system. A simple and cost-effective implementation on logic modules, i.e., microcontrollers and/or ASICs, having high data rates is made possible, this type of implementation being achievable on a printed circuit board with few connecting lines, and few pins of the logic module, i.e., low costs for the assembly and connection technology.

The users are configured in the communication system in the form of a ring topology, thus allowing the users to be connected via point-to-point connections with a minimum number of pins. In the ring topology, the slowest user determines the bus speed. A combination or grouping of users in different rings may optionally be provided, in each of these rings it being possible for a specific embodiment of the method according to the present invention to be carried out as a specific embodiment, complete in itself, of a communication system according to the present invention. If multiple functional groups are integrated into a control unit, for example, a microcontroller communicates with at least one ASIC of different functional units, the particular functional groups typically using a separate ring system in each case.

A microcontroller generally acts as the master, so that no bus arbitration is necessary. Thus, the master may cyclically query the slaves via so-called polling according to the present SPI protocol, which likewise is a master-slave concept.

A synchronous data transmission may occur according to the SPI standard. However, separate lines are not required for the data and the clock pulse. The provided interface provides an encoded transmission of the clock pulse within the data signal, for example an 8B/10B encoding, Manchester encoding, or Miller encoding, i.e., modified frequency modulation. Therefore, for low data rates only two pins per user, having one line each, are provided to the preceding and subsequent user. High data rates provide a differential transmission, with four pins per user having two lines each, provided to the preceding and subsequent user. Due to the encoded transmission of the clock information, in addition to the reduction in costs it may also be made possible that no delays occur between the clock pulse and the data on a transmission path between the users. A system clock is predefined by the master, and all slaves are synchronized with the aid of dedicated local clock recovery modules, for example via a phase-locked loop or by oversampling with appropriate synchronization to the message signal.

During the initialization at the start of a transmission, starting from a first interface from which data packets are sent, the master sends a synchronization signal, for example the intermediate frame symbol, to the first slave in the communication system, which is configured as a ring, for example. As soon as the system clock of the first slave, i.e., the receiver, is in phase with the master, the forwarding of the synchronization signal to the next slave begins. This operation continues through the entire communication system. After all slaves in the communication system, configured as a ring, for example, have been synchronized, a receiver in the master, usually a second interface via which data packets are received, may also be adapted. Due to the delay in the transmission of data frames or empty frames by the ring, which is unknown in the master, and the associated phase offset with respect to the internal system clock, phase tracking is also carried out in the master in a last step of the initialization. After the phase in the receiver of the master has also been tracked, all users are in phase, and data packets may now be synchronously transmitted.

To avoid frequency fluctuations of the clock recovery modules in the slaves due to continual resynchronization, continuous transmission of data, and thus of data packets, may be used in so-called continuous operation. The overhang for synchronization patterns at the start of a data packet, which is necessary in a packet-oriented transmission (so-called burst transmission mode) in contrast to so-called continuous transmission mode, is thus initially dispensed with. Due to the possibility of continuous synchronization, the slaves also do not require an additional system clock, which in known systems must generally be additionally supplied as well as the communication interface. Additional lines and pins may thus be saved. The continuous operation optionally provides for the use of a spread spectrum method for improving the EMC properties. In addition, the use of a packet-oriented transmission (so-called burst transmission mode) is also possible, although this may possibly require an additional line for transmitting the system clock from the master to the slaves.

In another embodiment, the users taking part in the communication have shift registers. Automatic clocking of the shift registers takes place, a clock pulse for the time base of the master, which is configured as a microcontroller, being recovered with the aid of a clock recovery module. The shift register automatically transmits the data via a clock signal of this clock pulse. Since the bits may be individually processed, the minimum latency time of one bit duration per user may be achieved. Latency times which result until a data packet having a message is transmitted by the ring are thus low, so that the real-time capability of the communication system may be ensured. Due to the minimum delay of the message by at least one clock pulse, signal conditioning, i.e., so-called bit reshaping, which may act in a level- and/or time-related manner, also takes place in each user.

In the communication system, the addressing of the users preferably does not take place via a separate selection signal; instead, addressing occurs within a data packet configured as a data frame or an empty frame. To detect the address field in the continuous data stream, the intermediate frame symbol, which in the embodiment corresponds to a start symbol and an end symbol of a data packet, is inserted.

The intermediate frame symbol may also be regarded as a preamble of a data frame, via which the slaves may be synchronized with the forthcoming data. The frame is synchronized in this way, since each user knows that data are always transmitted after the intermediate frame symbol. The intermediate frame symbol may also be used to convert variable data lengths.

The master may address the slaves via the addressing, and may write or read data via appropriate instructions.

Switching between different frame lengths may be carried out using the described interface. If a fixed frame length is selected, in some circumstances small data packets may be transmitted in a large frame. This requires filling the data frame with “dummy” data. A variable frame length is likewise implementable, whereby the lengths of the data registers in the slaves may be independent of one another, since the irrelevant data frames are only relayed through in each case.

In the case of variable frame lengths, via an empty frame the slaves may signal the master with a request that useful data are to be transmitted by the slave, according to which these useful data are subsequently picked up by the master by sending a data frame of appropriate length.

Via the empty frame, a slave obtains its address corresponding to the position in the ring. The master sends the empty frame having the address value 0x00, each slave incrementing the address value by the value 0x01 and storing the received value in its address register. Thus, an indirect address assignment occurs with the sending of an empty frame. Corresponding to the position in the ring, the slave may modify the interrupt bit assigned to it in the empty frame, and thus transmit an interrupt request to the master.

The slave may send an interrupt, for example a soft interrupt, to the master via an empty frame, and wait for the master to send an appropriate data frame to the slave in a next cycle.

This data frame is provided with a set reservation character and the address of the slave. The data frame may now once again contain, for example, the instruction to read out a register, according to which the slave subsequently copies the information that is present into the data frame.

In order to trigger signaling in this variant of the communication, a slave is prioritized based on the position of the slave in the communication system. In one embodiment of the interface, a slave may transmit a signal to the master by setting a bit that is assigned to the slave. The intermediate frame symbol and the reservation character are followed, corresponding to the number of slaves as users in the communication system, by a number of bits, which is at least as large as the number of users (which generally is the number of slaves in the communication system), which may trigger an interrupt. Users which only receive data from the master and do not deliver messages to the master accordingly have no interrupt capability, and therefore ignore the empty frames. Thus, for this type of user there is also no need to reserve an interrupt bit in the empty frame. If an interrupt is to be triggered by an interrupt-capable user, this user sets the bit assigned to it. The processing of the interrupts may now be prioritized in the master (microcontroller).

In another embodiment, error correction may also be added. If a communication system is ring-shaped, due to the ring topology the communication system may be configured in such a way that after the transmission by the ring, the master compares the received message to the message which it originally sent, and may thus deduce whether or not the transmission has errors. The response to a request by the slaves is generally sent directly to the master to ensure better capacity utilization of the system. Alternatively, the response of the slave may occur only with the next data packet that is addressed to it, corresponding to present configurations of SPI communication. Optionally, a cyclic redundancy check (CRC) may be carried out as a check sum process, or a parity check may be added in the data frame, and the receiving user acknowledges receipt at the end of its response.

The data may optionally be transmitted in such a way that a message containing data which are usually provided in a data frame and, originating from the sender, i.e., the master, completely transmitted by the ring, are once again decoded in the master before the next data frame is sent. Alternatively, a continuous bitstream of data may be selected; i.e., the next data frame is sent immediately, not until after the previous message is received. In this case, it is ensured in the protocol via arbitration that a soft interrupt of a slave is correctly processed when there is overlapping addressing by the master; i.e., the master addresses the slave even before the soft interrupt of the slave has been processed. This scenario is permissible, and has no influence on the design of the described bit transmission layer.

An additional logic module is optionally implemented in the master in order to write the received data, for example sensor data, directly into a memory. Furthermore, the polling of the slaves may be automated. This reduces the software interaction, which results in a relief of the central processing unit (CPU). In addition, the registers of the ASICs (slaves) may be transparently stored in the memory of the microcontroller (master). Possible hardware modules are known from the related art as DMA, transfer units, or also message boxes.

An interface for a user which is provided within the scope of the present invention may be used for applications in the automotive field. The mentioned interface is likewise universally usable according to the known standards such as inter-integrated circuit (IIC) and serial peripheral interface (SPI), and therefore is not limited to use in the automotive field, or even to use in control units (ECUs).

The communication system according to the present invention is configured to carry out all steps of the presented method. Individual steps of this method may also be carried out by individual components, usually by users, of the communication system. Furthermore, functions of the communication system or functions of individual components of the communication system may be implemented as steps of the method. It is also possible for steps of the method to be implemented as functions of at least one component of the communication system or of the overall communication system.

A serial type of transmission is selected for the configuration of the programmable hardware modules, in particular the FPGAs. The transmission path is configured as a ring structure (as described above). The clock pulse, as described above, is not transmitted separately, but instead is contained in the data signal. The data and the clock pulse are sent together in succession to all users. The users relay the data in the ring from user to user. Due to the ring structure of the data transmission, in particular an explicit acknowledgment line is also dispensed with here. The data transmission in the ring is possible forward or backwards, in duplex or half-duplex mode.

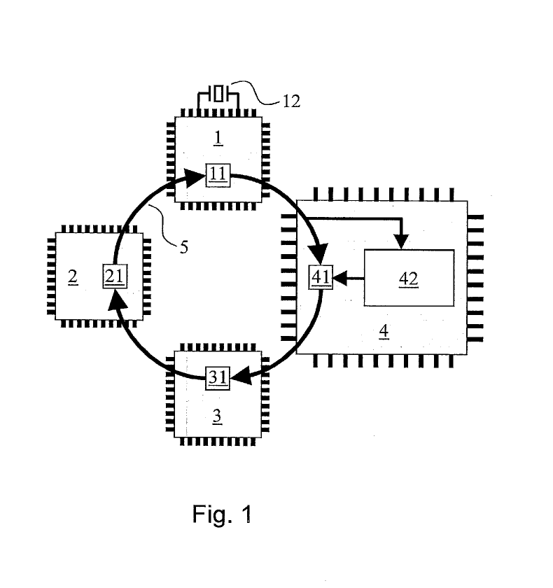

FIG. 1 shows a corresponding ring-shaped communication system in a simple configured. The communication system has a master 1 and slaves 2 through 4. Master 1 has a register 11 and a clock means 12. Slaves 2, 3, 4 have shift registers 21, 31, and 41, respectively. In addition, a clock recovery means 42 is indicated for slave 4, shown in greater detail, and is also representative of remaining slaves 2 and 3, via which a clock pulse of clock means 12 of master 1 may be recovered. A data stream 5 which includes data packets that are transmitted in the communication system is illustrated by arrows. As indicated in FIG. 1, the data stream runs in slaves 2, 3, 4 via shift registers 21, 31, 41, respectively. These may be 1-bit shift registers, resulting in a very small delay of one bit for data stream 5 in each case.

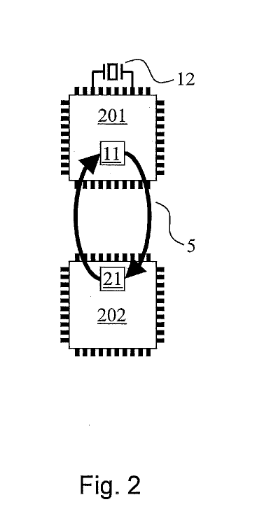

FIG. 2 shows a first embodiment of a communication system for configuring or programming a programmable hardware module, having only two lines. The communication system has only two users 201 and 202. User 201 is the master of the system, having clock means 12 and a register 11. In this embodiment, master 201 likewise includes a programmable hardware module, in particular an FPGA (not explicitly illustrated). Second user 202 is a slave, and in this embodiment includes a memory arrangement (not explicitly illustrated). The programmable hardware module of user 201 is configured in such a way that it may be configured by reading out data of a memory arrangement of user 202. In this embodiment, user 201 is the master, and therefore controls the configuration. Data stream 5 is once again illustrated by arrows.

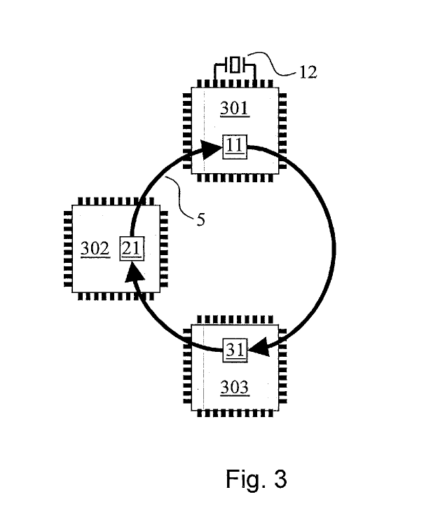

FIG. 3 shows another possible embodiment of a communication system for configuring or programming a programmable hardware module, in this case having three lines. User 301 is the master of the system, and has clock means 12 and a register 11. The two slaves 302 and 303 have shift registers 21 and 31, respectively. In this embodiment, slave 302 has a programmable hardware module (not explicitly shown). Slave 303 has a memory arrangement (not explicitly shown). Master 301 is configured as the configuration master, which includes means for configuring or programming the programmable hardware module of user 302 by reading out data of the memory arrangement of slave 303. Thus, in this embodiment neither the user having programmable hardware module 302 nor the user having a memory arrangement 303 is provided as the master; instead, there is a separate configuration master. Data stream 5 is once again illustrated by arrows.

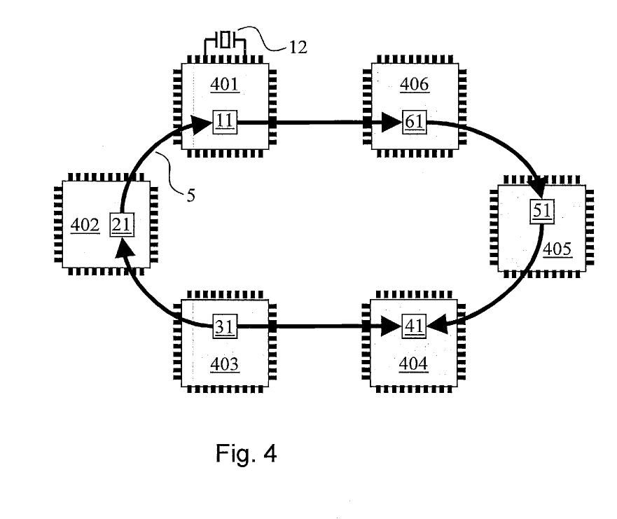

If it is necessary to configure multiple programmable hardware modules in various users (for example, for a factory configuration in production, or for multiple FPGAs in a system), in the proposed system this may be implemented in a particularly efficient manner using only one multiple line per new user. FIG. 4 shows a user 401 having a register 11 and clock means 12, which functions as the master, as well as users 402 through 406 having shift registers 21 through 61, respectively, which are configured as slaves. Data stream 5 is once again illustrated by arrows. In this specific embodiment, slaves 403 through 405 (not explicitly illustrated) have programmable hardware modules. Slave 402 has a memory arrangement (not explicitly shown). In this embodiment, user 401 is configured as the configuration master, comparable to user 301 in FIG. 3. User 401 now includes means for configuring or programming one, multiple, or all programmable hardware modules of users 403 through 406 by reading out data of the memory arrangement of user 402.

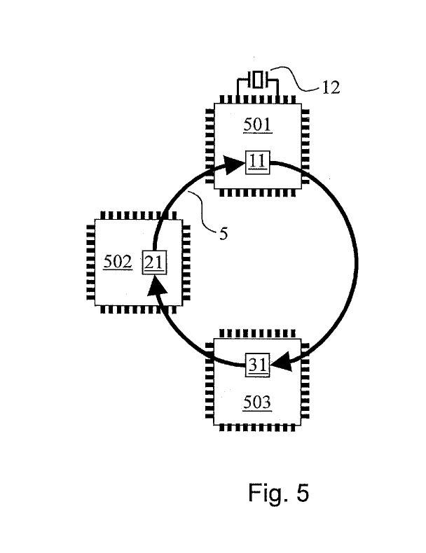

The system may likewise be implemented in a particularly advantageous manner using multiple users, which include a memory arrangement having data for configuring or programming one or multiple programmable hardware modules of one or multiple additional users of the ring-shaped communication system. This may be advantageous, for example, for reliability or security reasons, for example by redundantly storing the data necessary for the configuration in multiple memory arrangements. Such a configuration is shown in FIG. 5. User 501 is configured as the master, having a register 11 and clock means 12, and also has a programmable hardware module (not explicitly shown). The two remaining users 502 and 503 have shift registers 21 and 31, respectively, and in each case also include a memory arrangement (not explicitly illustrated). Data stream 5 is once again illustrated by arrows. In this configuration, user 501 having the programmable hardware module once again controls the configuration of same by reading out data of the memory arrangement of user 502 and/or of user 503. As an alternative to the illustrated configuration, multiple users, each having a memory arrangement, may be implemented on a shared integrated circuit (IC); i.e., an IC thus has multiple memory arrangements. One user may also have multiple memory arrangements.

In general, for the two variants shown in FIGS. 4 and 5, all possible variants including multiple users having a memory arrangement as well as multiple users having programmable hardware modules are possible in the described ring-shaped system. In particular for such fairly complex systems, due to the very small number of data lines the described system is particularly resource-efficient compared to known systems.

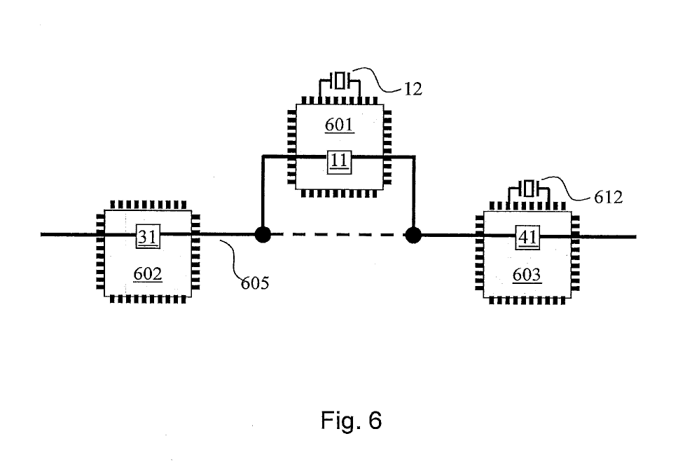

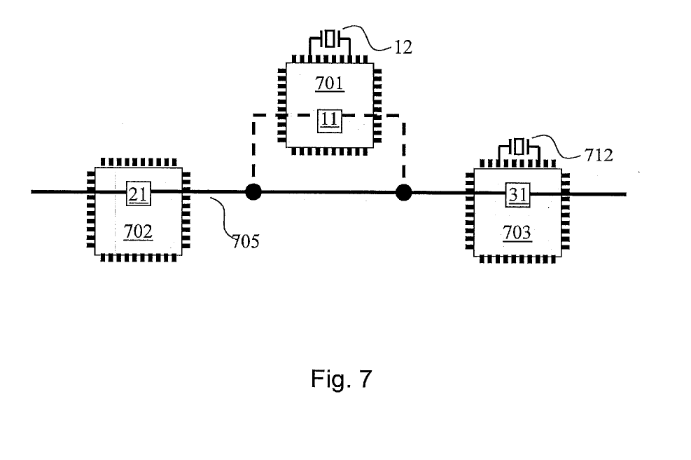

The previous figures have shown embodiments in which a user having a programmable hardware module functions as the master, or in which a specific user is configured as the configuration master. In the proposed communication system it is also possible for the master function to change. Such a system is shown in FIGS. 6 and 7.

FIG. 6 illustrates the system in a configuration phase in which user 601 is configured as the specific configuration master. User 601 includes a register 11 and clock means 12. The other user 602 includes a shift register 31 and a memory arrangement (not explicitly shown), while user 603 includes a shift register 41, clock means 612, and a programmable hardware module (not explicitly shown). Additional users may be present in the ring, although FIG. 6 shows only a detail having the described three users. The users are connected to one another via a communication connection 605, over which a data stream may run. The detail illustrated in dashed lines denotes a connection that is not closed, i.e., not present in this phase. In the configuration phase shown, users 602 and 603 function as slaves, and configuration master 601 controls the configuration or programming of the programmable hardware module of user 603 by reading out data of the memory arrangement of user 602.

FIG. 7 shows the corresponding detail of the ring-shaped communication system in FIG. 6 in a subsequent phase after the configuration phase. Users 701 through 703 correspond to users 601 through 603 in FIG. 6, and registers 11, 21, 31 and clock means 12 correspond to those in FIG. 6, communication connection 705 likewise corresponding to communication connection 605 in FIG. 6. In contrast to FIG. 6, user 701 is no longer situated in the ring-shaped communication system (illustrated by the dashed lines), and therefore also does not function as the master thereof. In this phase the master function is taken over by user 703, which has the programmable hardware module (not explicitly shown). Also in this phase, a configuration is thus possible in which control is carried out not just via the specific configuration master (701), but via user 703. The configuration or programming may once again be carried out by reading out data of the memory arrangement of user 703. Additional users, not shown in this detail, may once again be provided in the ring-shaped system.

If it is desired to not permanently maintain the configuration controller or configuration master in the system, the programmable hardware module, in particular FPGA, may be configured by a controller contained in the data ring, and after the configuration the controller may be removed. The ring may be reclosed without problems (for example, by a soldering jumper or by relaying the data ring). Thus, the master for the configuration also does not have to be permanently defined, and may change during operation. The position of the master in the ring may also be similarly changed.

As an alternative to removing the controller, the controller may remain in the ring even after the configuration phase and, for example, take over a different task there (multifunctional adapter). In principle, any user configured for this purpose may function as the master, and thus, the configuration controller, regardless of its position in the data ring.

The communication systems shown in FIGS. 1 through 7 have a configuration which corresponds to the above-described ring-shaped serial communication system. The communication of the data, the addressing of the users, etc., likewise take place as stated above. For all exemplary embodiments, the users, as illustrated in the figures, may each be implemented by an individual IC, or alternatively, multiple or also all users of the communication system may be implemented in a shared IC.

In all specific embodiments shown it is possible to put the programmable hardware module or the user which includes same into standby or sleep mode via a message, and to reactivate same by another message to this receiver.

The proposed interface may be a freely programmed interface of the configuration controller and/or of the programmable hardware module. However, the interface may also be implemented in a fixed manner as a semiconductor circuit, and be contained in the configuration controller and/or the programmable hardware module. The configuration interface may be used as a standard data interface during normal operation.

What is claimed is:

1. A communication system, comprising:
a ring-shaped configuration having at least two users which are connected to one another in series, one of the users being configured as the master and other ones of the users being configured as slaves, the master being configured to transmit a data packet to one or multiple slaves, and each slave having a shift register;
wherein at least one of the users in the communication system includes a programmable hardware module, at least one of the users in the communication system includes a memory arrangement, and the programmable hardware module is configured so that it may be configured by reading out data of the memory arrangement.

2. The communication system of claim 1, wherein the programmable hardware module has a programmable logic system, which is a field programmable gate array.

3. The communication system of claim 1, wherein the user having the programmable hardware module is the master.

4. The communication system of claim 1, wherein the user having the programmable hardware module is a slave.

5. The communication system of claim 1, wherein the master controls the configuration.

6. The communication system of claim 1, wherein multiple users in the ring-shaped communication system have programmable hardware modules.

7. The communication system of claim 1, wherein multiple users in the ring-shaped communication system have a memory arrangement.

8. A method for configuring a programmable hardware module, in which at least two users are situated in a ring-shaped communication system and are connected to one another in series, one user being configured as the master and the remaining users being configured as slaves, the master transmitting data packets to one or multiple slaves, and the data packets running in the slaves via a shift register, the method comprising:
configuring the programmable hardware module of a user of the communication system by reading out data of a memory arrangement of a user of the communication system.

9. The method of claim 8, wherein the user having the programmable hardware module controls the configuration as the master.

10. The method of claim 8, wherein in a configuration phase, the master is implemented by a configuration module situated in the ring-shaped communication system, and controls the configuration.

11. The method of claim 10, wherein after the configuration phase, the configuration module is removed from the ring-shaped communication system, and a different user of the ring-shaped communication system functions as the master.
